(19) United States
(12) Patent Application Publication
(10) Pub. No.: US 2025/0232090 A1
(43) Pub. Date: Jul. 17, 2025

(54) SYSTEM AND METHOD CONFIGURED TO ALLOCATE RESOURCES USING DESCRIPTORS PROCESSED BY ARTIFICIAL INTELLIGENCE

(71) Applicant: SAUDI ARABIAN OIL COMPANY, Dhahran (SA)

(72) Inventor: Robert Peter Hodgkins, Dhahran (SA)

(73) Assignee: SAUDI ARABIAN OIL COMPANY, Dhahran (SA)

(21) Appl. No.: 18/411,635

(22) Filed: Jan. 12, 2024

(51) Int. Cl. G06F 30/27; G06F 40/20

(52) U.S. Cl. CPC G06F 30/27; G06F 40/20

(57) ABSTRACT

A system and method resources using data descriptors processed by artificial intelligence to allocate resources of an organization for performing research and development (R&D). The system includes a processor, a memory, and a set of modules including a descriptor generating module, a filter module, a path generating modules, and an allocation generating module. The descriptor generating modules generates scientific descriptors from a specification, and generates a non-scientific descriptor from input data. The filter module filters the scientific descriptors using the non-scientific descriptor to generate filtered scientific descriptors. The path generating module uses the filtered scientific descriptors to generate a viable R&D path. The allocation generating module uses the viable R&D path to allocate the resources to implement the specification. The method implements the system.

### FIELD OF THE DISCLOSURE

The present disclosure relates generally to allocation of resources, and, more particularly, to a system and method configured to allocate resources for research and development using descriptors processed by artificial intelligence.

### BACKGROUND OF THE DISCLOSURE

In material science, a known, an unknown, or a simulated material is evaluated by the performance of such materials in an application. For example, the performance of a composite material used in an aircraft wing is evaluated, such as the stresses and strains of such composites during operation of the aircraft over numerous instances of flight of the aircraft, or over numerous simulations of the performance of the composite materials. Such evaluation methods lead to suggestions as to how to improve the material.

Artificial intelligence (AI) techniques have applied scientific descriptors to generate the suggestions for improvements to design a new material. The scientific descriptors correspond to new properties, new compositions, and new methodologies. In one implementation, the scientific descriptors describe properties of a material, such as a physical property of a material, a chemical property of a material, or a compositional property of a material. In another implementation, the scientific descriptors describe a composition of a material, such as the basic elements or components of a material. In a further implementation, the scientific descriptors describe a methodology associated with a material, such as a mechanical fabrication process, a chemical process, or a biological process configured to create, realize or grow the material.

Accordingly, the generated new material design is used by known systems to allocate the available resources to fabricate, create, realize, or grow a new material based on the AI-generated material design. However, artificial intelligence has not been used to remove such scientific descriptors which may not yield a viable research and development (R&D) resource deployment path, even if the scientific descriptors generated by the AI would allow for improved performance in the application. Therefore, by using only scientific descriptors, such resource allocation for a new material generates both viable and unviable resource allocations. Accordingly, processing time and speed are also allocated to such unviable resource allocations, wasting time and financial resources.

### SUMMARY OF THE DISCLOSURE

According to an implementation consistent with the present disclosure, a system and method are configured to allocate resources for research and development using descriptors processed by artificial intelligence.

In an implementation, a resource allocation system comprises a hardware-based processor, a memory, and a set of modules. The memory is configured to store instructions and configured to provide the instructions to the hardware-based processor. The set of modules is configured to implement the instructions provided to the hardware-based processor. The set of modules includes a descriptor generating module, a filter module, a path generating module, and an allocation generating module. The descriptor generating module is configured to generate a plurality of scientific descriptors from a specification, and to generate a non-scientific descriptor from input data. The filter module is configured to filter the plurality of scientific descriptors using the non-scientific descriptor, thereby to generate a filtered set of scientific descriptors. The path generating module is configured, responsive to the filtered set of scientific descriptors, to generate at least one viable research and development (R&D) path. The allocation generating module is configured, responsive to the at least one viable R&D path, to allocate a plurality of resources to implement the specification.

The specification can include at least one first string of alphanumeric characters. The descriptor generating module can include an artificial intelligence module configured to extract a first keyword from the at least one first string of alphanumeric characters, and to generate the plurality of scientific descriptors from the extracted first keyword, any other input data, or both. The input data can include at least one second string of alphanumeric characters. The artificial intelligence module can be configured to extract a second keyword from the at least one second string of alphanumeric characters, and to generate a plurality of non-scientific descriptors from the extracted second keyword, any other input data, or both. The artificial intelligence module can include a natural language processing (NLP) module configured to extract a first keyword from the at least one first string of alphanumeric characters.

Alternatively, the filter module can include an artificial intelligence module configured to filter the plurality of scientific descriptors using the non-scientific descriptor. The path generating module can be configured, responsive to the filtered set of scientific descriptors, to generate a plurality of viable research and development (R&D) paths. The path generating module can be configured to sort and rank the plurality of viable R&D paths based on a predetermined ranking criterion. The path generating module can be configured to sort and rank the plurality of viable R&D paths from least costly to most costly as the predetermined ranking criterion. Alternatively, the path generating module can be configured to sort and rank the plurality of viable R&D paths from a greatest return on investment (ROI) to a least ROI as the predetermined ranking criterion. In other implementations, the predetermined ranking criterion uses any known factors, such as legislation, regulations, legal issues, sustainability, perceptions, and business considerations.

In another implementation, a system comprises a specification source, a data source, and a resource allocation sub-system. The specification source is configured to store a specification having at least one first string of alphanumeric characters. The data source is configured to store input data having at least one second string of alphanumeric characters. The resource allocation sub-system includes a hardware-based processor, a memory, and a set of modules. The memory is configured to store instructions and configured to provide the instructions to the hardware-based processor. The set of modules is configured to implement the instructions provided to the hardware-based processor. The set of modules includes a descriptor generating module, a filter module, a path generating module, and an allocation generating module. The descriptor generating module is configured to generate a plurality of scientific descriptors from the specification, and to generate a non-scientific descriptor from the input data. The filter module is configured to filter the plurality of scientific descriptors using the non-scientific descriptor, thereby to generate a filtered set of scientific descriptors. The path generating module is configured, responsive to the filtered set of scientific descriptors, to generate at least one viable research and development (R&D) path. The allocation generating module is configured, responsive to the at least one viable R&D path, to allocate a plurality of resources to implement the specification.

The descriptor generating module can include an artificial intelligence module configured to extract a first keyword from the at least one first string of alphanumeric characters, and to generate the plurality of scientific descriptors from the extracted first keyword, any other input data, or both. The artificial intelligence module can be configured to extract a second keyword from the at least one second string of alphanumeric characters, and to generate a plurality of non-scientific descriptors from the extracted second keyword, any other input data, or both. The artificial intelligence module can include a natural language processing (NLP) module configured to extract a first keyword from the at least one first string of alphanumeric characters. Alternatively, the filter module can include an artificial intelligence module configured to filter the plurality of scientific descriptors using the non-scientific descriptor.

The path generating module can be configured, responsive to the filtered set of scientific descriptors, to generate a plurality of viable research and development (R&D) paths. The path generating module can be configured to sort and rank the plurality of viable R&D paths based on a predetermined ranking criterion. The path generating module can be configured to sort and rank the plurality of viable R&D paths from least costly to most costly as the predetermined ranking criterion. Alternatively, the path generating module can be configured to sort and rank the plurality of viable R&D paths from a greatest return on investment (ROI) to a least ROI as the predetermined ranking criterion. In other implementations, the predetermined ranking criterion uses any known factors, such as legislation, regulations, legal issues, sustainability, perceptions, and business considerations.

In a further implementation, a computer-based method comprises providing a specification having at least one first string of alphanumeric characters, providing input data having at least one second string of alphanumeric characters, generating a plurality of scientific descriptors from the specification, generating a non-scientific descriptor from the input data, and filtering the plurality of scientific descriptors using the non-scientific descriptor, thereby generating a filtered set of scientific descriptors. Responsive to the filtered set of scientific descriptors, the computer-based method further comprises generating at least one viable research and development (R&D) path. Responsive to the at least one viable R&D path, the computer-based method further comprises allocating a plurality of resources to implement the specification. Generating the plurality of scientific descriptors can further comprise performing natural language processing (NLP) on the at least one first string of alphanumeric characters in the specification, extracting a first keyword from at least one first string of alphanumeric characters, and generating the plurality of scientific descriptors from the extracted first keyword, any other input data, or both.

Any combinations of the various embodiments, implementations, and examples disclosed herein can be used in a further implementation, consistent with the disclosure. These and other aspects and features can be appreciated from the following description of certain implementations presented herein in accordance with the disclosure and the accompanying drawings and claims.

### BRIEF DESCRIPTION OF THE DRAWINGS

FIG. 1 is a schematic of a system, according to an implementation.

FIG. 2 is a schematic of a computing device used in the implementation.

FIGS. 3A-3B illustrate example specifications.

FIG. 4A illustrates an example of a plurality of scientific descriptors extracted from the specification in FIG. 3A.

FIG. 4B illustrates an example of a plurality of non-scientific descriptors extracted from the specification in FIG. 3A or input data from a data source.

FIGS. 5A-5B illustrate examples of filtered sets of the scientific descriptors of FIG. 4A.

FIG. 6A illustrates an example of at least one viable path for research and development.

FIG. 6B illustrates an example of no viable path for research and development.

FIG. 7 illustrates an example of a ranked set of viable research and development paths shown in FIG. 6A.

FIGS. 8A-8B are a flowchart of a method of operation of the system of FIG. 1.

It is noted that the drawings are illustrative and are not necessarily to scale.

### DETAILED DESCRIPTION OF CERTAIN EMBODIMENTS OF THE DISCLOSURE

Example embodiments and implementations consistent with the teachings included in the present disclosure are directed to a system 100 and method 800 configured to allocate resources for research and development using descriptors processed by artificial intelligence.

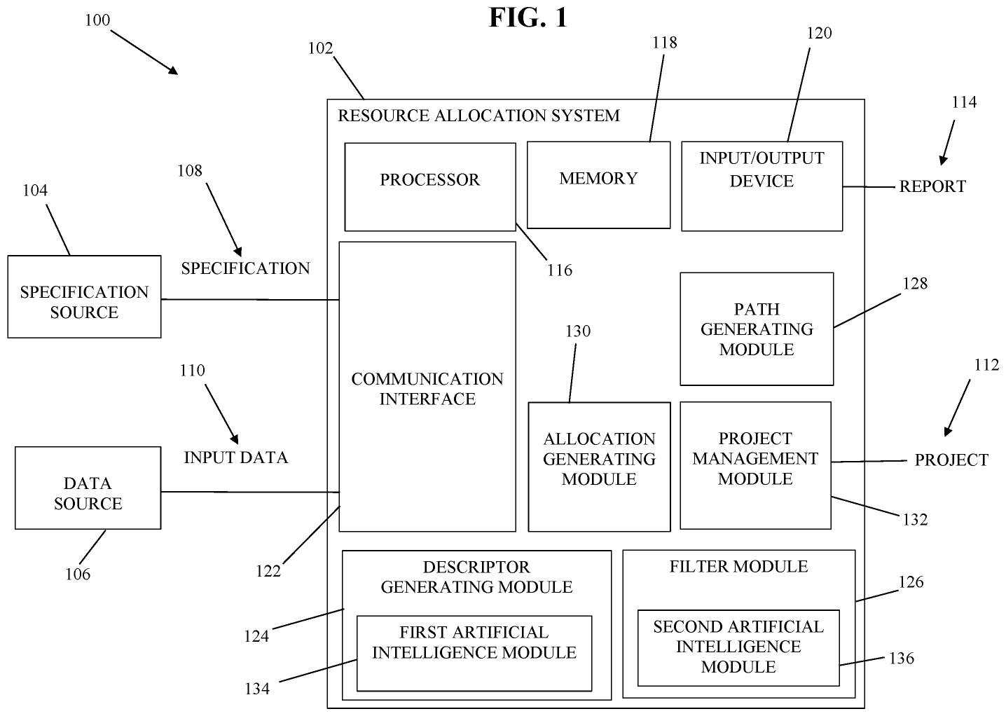

As shown in FIG. 1, in one implementation consistent with the invention, the system 100 includes a resource allocation system 102 operatively connected to a specification source 104 and optionally operatively connected to a data source 106. In another implementation, the resource allocation system 102 is a sub-system of the system 100. The specification source 104 transmits or otherwise provides a specification 108 to the resource allocation system 102. The data source 106 transmits or otherwise provides input data 110 to the resource allocation system 102. In one implementation, each of the specification source 104 and the data source 106 is a database. In another implementation, each of the specification source 104 and the data source 106 is a server. In one implementation, the resource allocation system 102 is operatively connected to the specification source 104 and the data source 106 through a network. For example, the network is the Internet. In another example, the network is an internal network or intranet of an organization. In a further example, the network is a heterogeneous or hybrid network configured to provide access of the resource allocation system 102 to the specification source 104 and the data source 106 through the Internet and an intranet.

In one implementation consistent with the invention, the specification 108 is a description. For example, the description include a structure, a composition, a property, performance information, a function, a method, a process, or an operating parameter. In one implementation, the specification 108 is a description of a material or a composition of matter to be fabricated, created, realized, or grown, such as a composite material. For example, the material or the composition of matter is a chemical including a catalyst, a polymer, or a pharmaceutical. In another implementation, the specification 108 is a description of a machine to be fabricated, such as a computer-based device. In a further implementation, the specification 108 is a goal of a project, such as the project 112. For example, the project 112 is configured to design, simulate, fabricate, create, realize, or grow a material or a composition of matter, such as a chemical including a catalyst, a polymer, or a pharmaceutical. In another example, the project 112 is configured to design, simulate, fabricate, or create a software project such as an application. In a further example, the project 112 is a research and development (R&D) program. In yet another example, the specification 108 describes any known item, idea, application, or process to be designed, simulated, fabricated, created, realized, or grown.

In one implementation, in the case that the specification 108 describes a material, the specification 108 describes a structure of a known material. In an additional implementation, the specification 108 describes a composition of a known material. In another implementation, the specification 108 describes a property of a known material. In a further implementation, the specification 108 describes a performance of a known material. In an additional implementation, the specification 108 describes a function of a known material. In a further implementation, the specification 108 describes a method to make a known material. In still another implementation, the specification 108 describes an operating parameter of a known material.

Alternatively, in one implementation, the specification 108 describes a structure of an unknown material. In an additional implementation, the specification 108 describes a composition of an unknown material. In another implementation, the specification 108 describes a property of an unknown material. In a further implementation, the specification 108 describes a performance of an unknown material. In an additional implementation, the specification 108 describes a function of an unknown material. In a further implementation, the specification 108 describes a method to make an unknown material. Accordingly, the specification 108 describes a desired structure, a desired property, a desired performance, a desired function, or a desired method of making an unknown material. In still another implementation, the specification 108 describes an operating parameter of an unknown material.

In another alternative, in one implementation consistent with the invention, the specification 108 describes a structure of a simulated material. In an additional implementation, the specification 108 describes a composition of a simulated material. In another implementation, the specification 108 describes a property of a simulated material. In a further implementation, the specification 108 describes a performance of a simulated material. In an additional implementation, the specification 108 describes a function of a simulated material. In a further implementation, the specification 108 describes a method to make a simulated material. In still another implementation, the specification 108 describes an operating parameter of a simulated material.

For example, the material is a composite. In another example, the material is a low-temperature superconductor. In a further example, the material is a carbon-capture filter configured to selectively absorb carbon dioxide from the air or flue gas using porous organic molecules. In an additional example, the material is a lithium-ion battery configured to store more energy and last longer using novel electrode materials and electrolytes. In a further example, the material is a perovskite-based material configured as a solar cell that converts more sunlight into electricity. In another example, the material is a semiconductor configured as an electronic device. In an additional example, the material is a ferroelectric material configured as a memory device to store data with artificial polarization. In another example, the material is a pharmaceutical used to diagnose, treat, or prevent disease, or to restore, correct, or modify organic functions. In yet another example, the material is any type of composition of matter such as a catalyst.

In one implementation, the specification 108 is manually inputted or created by a user, such as a material scientist or engineer, through an input device, such as the input/output device 120. For example, the input/output device includes a keyboard, a keypad, a touchscreen, or a mouse configured to control a computing device such as a personal computer, a laptop, a tablet, or a telephone such as a smartphone. The input or created specification 108 is saved, for example, in the data source 106. In another example, the input or created specification 108 is transmitted or otherwise provided to the resource allocation system 102. In another implementation, the specification 108 is automatically created from a known material, an unknown material, or a simulated material, as described above. For example, the specification 108 is automatically created using any known artificial intelligence module applying artificial intelligence techniques to process information about the known material, the unknown material, or the simulated material. In one implementation, as described above, the information used to automatically generate the specification 108 is a scientific descriptor, such as a new property, a new composition, or a new methodology. The automatically generated specification 108 is stored in the data source 106. Alternatively, the automatically generated specification 108 is transmitted or otherwise provided to the resource allocation system 102.

In one implementation consistent with the invention, the system 100 and method 800 use the specification 108 to determine an allocation of resources to fabricate a new material according to or meeting the specification 108. In another implementation, the system 100 and method 800 use the specification 108 to determine an allocation of resources to create a new material according to or meeting the specification 108. In another implementation, the system 100 and method 800 use the specification 108 to determine an allocation of resources to grow a new material according to or meeting the specification 108. In a further implementation, the system 100 and method 800 use the specification 108 to determine an allocation of resources to realize, cleave, shorten, cut, or reduce in size a new material or bond according to or meeting the specification 108. In an additional implementation, the system 100 and method 800 use the specification 108 to determine an allocation of resources to simulate a new material according to or meeting the specification 108.

In one implementation, the specification 108 is a text file listing the structure, composition, property, performance, functionality, method to make, and other known or desired characteristics of a material. For example, the text file is in a predetermined natural language, such as English. In other example, the text file is a computer-based mark-up language configured to encode information about the structure, composition, property, performance, functionality, method to make, and other known characteristics of a material. In one implementation, the specification 108 is formatted using an Extensible Markup Language (XML). In another implementation, the specification 108 is formatted using a Standard Generalized Markup Language (SGML). In an alternative implementation, the specification 108 includes data in a format configured to be stored and processed in a relational database management system. For example, the specification 108 is in a Structured Query Language (SQL) format. In a further implementation, the specification 108 is in a programming language. In other implementations, the specification 108 is in any known data format.

In a further implementation, the specification 108 from the specification source 104 includes any known data in any format. For example, the specification 108 includes plotted data. In another example, the specification 108 includes a graph of data. In a further example, the specification 108 includes a table of data. In an additional example, the specification 108 includes a figure. In still another example, the specification 108 includes an image. In another example, the specification 108 is a trend in data. In another example, the specification 108 is an impact on changes to a variable or multiple variables.

In one implementation, the specification 108 is stored in the data source 106. In another implementation, the specification 108 is stored in an external data source, such as a server. For example, the server is a web server configured to provide the specification 108 through the Internet or an intranet to the resource allocation system 102. The data source 106 is configured to store and provide the input data 110 to the resource allocation system 102. For example, the data source 106 stores project data describing the characteristics and progress of a project 112. In another example, the data source 106 stores data descriptors, such as scientific descriptors, business descriptors, commercial descriptors, and legal descriptors. In one implementation, the data source 106 includes a patent database of published patents and patent publications, with the patent database queried using keywords and phrases to find pertinent published patents and patent publications. In another implementation, the data source 106 stores market reports, business and commercial literature, and publications which describe company activities, research, beta tests of products, and technology trends. In a further implementation, the data source 106 stores any known data in any known field, such as science, business, commerce, technology, history, culture, political issues, and ecological and environmental issues, as well as relevant global, national, or local legislation, standards, conventions, treaties, etc. which involve the materials or other goals set forth in the specification 108. In still another implementation, the data source 106 stores the input data 110 received from researchers, project team members, project managers, and other members of an organization. For example, the input data 110 is input into the data source 106 by such researchers, project team members, project managers, and other members of the organization using an input device external to the resource allocation system 102. In another example, the input data 110 is input into the data source 106 by such researchers, project team members, project managers, and other members of the organization using the input/output device 120 of the resource allocation system 102. In a further implementation, the input data 110 includes specific words, strings of characters, trends, plotted data, graph of data, table of data, figures, images, trends of data, and other data. For example, such specific words, strings of characters, trends, plotted data, graph of data, table of data, figures, images, trends of data, and other data are input into the data source 106 by such researchers, project team members, project managers, and other members of the organization using the input device.

In an additional implementation, the input data 110 from the data source 106 includes any known data in any format. For example, the input data 110 includes plotted data. In another example, the input data 110 includes a graph of data. In a further example, the input data 110 includes a table of data. In an additional example, the input data 110 includes a figure. In still another example, the input data includes an image. In another example, the input data 110 is a trend in data. In another example, the input data 110 is an impact on changes to a variable or multiple variables.

In one implementation, a data descriptor is a keyword. For example, the keyword is a string of alphabetical symbols or characters. In another example, the keyword is a string of alphanumerical symbols or characters. In a further example, the keyword is a string of any known symbols or characters. In one implementation, the string of symbols or characters form a valid word in a predetermined language. If the predetermined language is English, an example keyword is “composite”. In another example, the keyword is an acronym or abbreviation in a predetermined language, such as English. An example acronym as a keyword is “ISO” describing the International Organization for Standardization (ISO). In a further example, the keyword is a valid composition, such as a chemical formula. An example composition as a keyword is “CO2”.

In another implementation, a data descriptor is at least one keyword. In a further implementation, a data descriptor is a plurality of symbols separated by a delimiter, such that a sequence of one or more symbols uses a predetermined symbol as a delimiter specifies a boundary between separate, independent regions in plain text, mathematical expressions, or other data streams. For example, the delimiter is a blank space, such as the blank space in “ISO 9000” describing a specific ISO-based methodology. In another example, the delimiter is a dash. In yet another example, the delimiter is any predetermined symbol, such as an underline. In one implementation, the plurality of symbols or characters form at least one keyword. In another implementation, the plurality of symbols or characters form a plurality of keywords. For example, a data descriptor such as “cuprate-perovskite composite” describes a high temperature superconductor. In a further implementation, the plurality of symbols or characters form a valid phrase in a predetermined language, such as English. For example, a data descriptor such as “perform spectroscopy on a material” is a valid phrase in English.

In another implementation, a data descriptor is a formatted string of symbols or characters with external delimiters, such as <composite> or <perform spectroscopy on a material>. For example, the external delimiter is an angle bracket such as “<” or “>”. In another example, the external delimiter is a parenthesis such as “(” or “)”. In a further example, the external delimiter is a brace such as “{” or “}”. In still another example, the external delimiter is a bracket such as “[” or “]”. In an additional example, the external delimiter is a single quotation mark. In a further example, the external delimiter is any predetermined single symbol, such as a single “#” or “@” on either horizontal side of the delimited characters. In an alternative example, the external delimiter is any predetermined pair of symbols, such as “!” and “?”, with one predetermined symbol such as “!” on a left side of the characters, and the other predetermined symbol such as “?” on a right side of the characters. In yet another example, the external delimiter is a combination of symbols or characters, such as “<? ” and “?>”, or “/*” and “*/”, or “<%” and “/>”.

In one implementation, a data descriptor conforms to a document type definition (DTD), which is a specification file that contains a set of markup declarations. In another implementation, a data descriptor conforms to a predetermined schema, such as an XML Schema Definition (XSD). By using such keywords, and optionally using delimiters, the system 100 is configured to receive and process a string of symbols or characters by parsing and extracting at least one keyword or phrase using known parsing techniques.

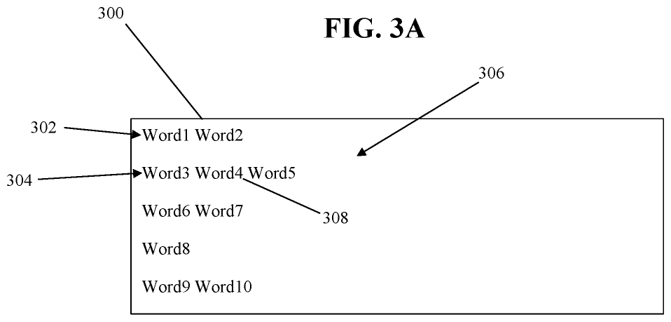

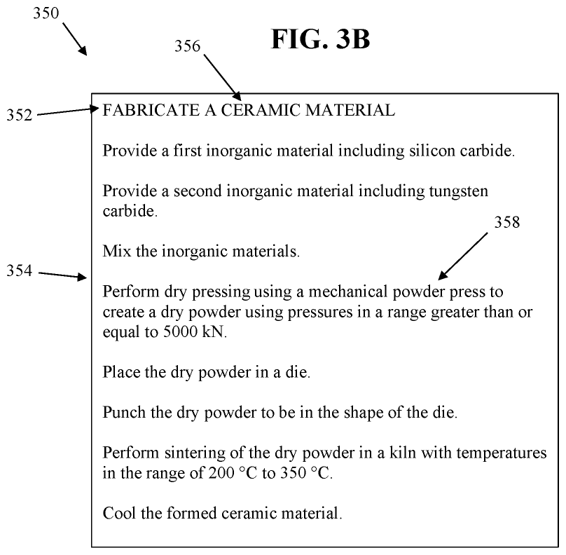

FIGS. 3A-3B illustrate example specifications included as the specification 108 from the specification source 104. FIG. 3A illustrates a specification 300 having at least one phrase 302 or at least one instruction 304, each including at least one word 306. The at least one word 306 is a string of symbols or characters, as described above. As described below, the descriptor generating module 124 includes a first artificial intelligence (AI) module 134 configured to identify a keyword 308, such as “Word4”, among the at least one word 306. Using the keyword 308, the descriptor generating module 124 generates a scientific descriptor such as <keyword>. For example, if Word4 is “ceramic”, the descriptor generating module 124 generates a scientific descriptor <ceramic>. FIG. 3B illustrates a more detailed example of a specification 350, in which at least one phrase 352 or at least one instruction 354 is described to fabricate a ceramic material. For example, the at least one phrase 352 includes “FABRICATE A CERAMIC MATERIAL”, and the at least one instruction 354 includes “Perform dry pressing using a mechanical powder press to create a dry powder using pressures in a range greater than or equal to 5000 kN.” Each of the at least one phrase 352 or at least one instruction 354 includes at least one keyword 356, 358, respectively, such as “CERAMIC” and “mechanical powder press”, respectively. Such specifications 300, 350 are input to the resource allocation system 102 as the specification 108 in FIG. 1. In one implementation, the specifications 300, 350, as the specification 108, are input to the communication interface 122 of the resource allocation system 102.

Referring to FIG. 1, the report 114 includes a message or notification generated and output to a user by the resource allocation system 102, as described below. In one implementation, the report 114 lists an allocation of resources configured to create, fabricate, grow, or realize a new material. For example, the report 114 is a text or graphic displayed visually on a display or monitor, with the report 114 visually or graphically listing the allocation and is output to a project manager or project team. In another example, the report 114 is an audible report output as audio through a speaker of the input/output device 120. In still another example, the report 114 is a computer file listing the allocation of resources which is automatically sent to a fabrication system, such as a three-dimensional (3D) printer, to implement the fabrication of a material using the allocation of resources. Alternatively, the fabrication system is a chemical plant operating in connection with petrochemical production, with the report 114 including control data and a resource allocation to implement the fabrication of new substances as a material using the allocation of resources provided to the chemical plant, such as raw materials and ingredients.

In another implementation, the report 114 describes a viable path forward for research and development performed by an R&D program. The viable path is determined with respect to potential business descriptors, commercial descriptors, legal descriptors, and other known types of descriptors, such as scientific descriptors. For example, the report 114 is a text or graphic displayed visually on a display or monitor, with the report 114 output to an R&D administrator or manager, or to a business executive of an organization. In another example, the report 114 displays a ranking of the preferred path forward among a plurality of R&D paths, as described below.

In one implementation, the project 112 includes information, components, resources, and equipment of an organization to perform and complete project tasks and sub-tasks, for example, directed to a new material. The resource allocation described herein is generated from a business or commercial sense or from a business or commercial perspective to better direct resources to progress the project 112, for example, to fabricate, create, grow, or realize the new material. In one implementation, the new material is a physical, chemical, or biological substance. In another implementation, the new material is a physical product, a process, a methodology, or a software-based application. In a further implementation, the new material is a combination of physical, chemical, or biological substances and a physical product, a process, a methodology, or a software-based application.

In another implementation, the project 112 includes information, components, resources, and equipment of an organization to perform and complete project tasks and sub-tasks, for example, directed to a simulated material. The resource allocation described herein is generated from a business or commercial sense or from a business or commercial perspective to better direct resources to progress the project 112, for example, to fabricate, create, grow, or realize the simulated material. In one implementation, the simulated material is a physical, chemical, or biological substance. In another implementation, the simulated material is a physical product, a process, a methodology, or a software-based application. In a further implementation, the simulated material is a combination of physical, chemical, or biological substances and a physical product, a process, a methodology, or a software-based application.

As shown in FIG. 1, the resource allocation system 102 includes a hardware-based processor 116, a memory 118, an input/output device 120, a communication interface 122, and a set of modules 124-136. The memory 118 is configured to store instructions and configured to provide the instructions to the hardware-based processor 116. The set of modules 124-136 is configured to implement the instructions provided to the hardware-based processor 116. The set of modules includes a descriptor generating module 124, a filter module 126, a path generating module 128, an allocation generating module 130, a project management module 132, a first artificial intelligence (AI) module 134, and a second artificial intelligence module 136.

The descriptor generating module 124 includes the first artificial intelligence module 134. In response to receiving the specification 108, the descriptor generating module 124 parses the specification 108 using the first artificial intelligence module 134 to generate data descriptors. The data descriptors include scientific descriptors, business descriptors, commercial descriptors, and legal descriptors which correspond to the material described in the specification 108. In one implementation, the first artificial intelligence module 134 includes a natural language processing (NLP) module using known NLP techniques to parse the specification 108 and to extract associated data. The NLP module generates a data descriptor from the extracted data. In another implementation, the first artificial intelligence module 134 includes a large language model (LLM), such as a language model configured to perform general-purpose language understanding and generation. For example, an LLM is configured to acquire such general-purpose language understanding and generation capabilities by learning statistical relationships from text documents during a computationally intensive self-supervised or semi-supervised training process. In one implementation, an LLM includes an artificial neural network following a transformer architecture.

Other known artificial intelligence techniques are implemented by the first artificial intelligence module 134, such as a module implementing machine learning (ML), deep learning (DL), logistic regression, linear regression, vector processing, mean and statistical data processing, artificial neural networks, decision-making, naïve Bayes classifier, K-nearest neighbors algorithms, K-means clustering, Q-learning, reinforcement learning, supervised learning, unsupervised learning, self-aware processing, theory of mind processing, limited memory processing, reactive processing, text AI, visual AI, interactive AI, analytical AI, functional AI, support vector machine techniques, random forest processing, cluster analysis, eXtreme gradient boosting (XGBoost), generative pre-trained transformer (GPT) processing, or a combination thereof.

In one implementation, the specification 108 describes a ceramic material for use in pipelines, such as in oil and gas production. For example, from keywords in the specification 108, the first artificial intelligence module 134 generates the following scientific descriptors from keywords in the specification 108: <ceramic>, <ceramic-pipeline>, <non-metallic-pipeline>, and <chemically-bonded-phosphate-ceramic>. In another example, the first artificial intelligence module 134 also generates the following business descriptors from keywords in the specification 108: <EonCoat> and <Pingxiang-Chemshun-Ceramics>. In a further example, the first artificial intelligence module 134 also generates the following commercial descriptors from keywords in the specification 108: <ISO-24565-ceramic-lined-oil-pipe> and <ceramics-lined-industry-pipeline>. In still another example, the first artificial intelligence module 134 generates the following legal descriptors from keywords in the specification 108: <US20230358355> and <US20230020861>.

In an implementation consistent with the invention, the descriptor generating module 124 also uses the first artificial intelligence module 134 to parse the input data 110 from the data source 106 and to generate non-scientific descriptors corresponding to the parsed input data 110. The first artificial intelligence module 134 uses any known NLP method to parse the input data 110 and to generate the non-scientific descriptors. In one implementation, the non-scientific descriptors include business descriptors, commercial descriptors, legal descriptors, etc. For example, based on the input data 110, business descriptors such as <start-up>, <incubator>, or <investment-capital>; commercial descriptors such as <market-share-less-than-ten-percent> and <budget-less-than-$1000000>, or other manufacturing costs and techno-economics factors; and legal descriptors such as <no-freedom-to-operate> and <possible-patent-infringement> are generated by the descriptor generating module 124 using the first artificial intelligence module 134. In another implementation, the data source 106 stores any known data in any known field, such as science, business, commerce, technology, history, culture, political issues, ecological and environmental issues, as well as relevant global, national, or local legislation, standards, conventions, treaties, etc. The data source 106 provides such science, business, commerce, technology, history, culture, political issues, ecological and environmental issues, as well as relevant global, national, or local legislation, standards, conventions, treaties, etc. as the input data 110. The descriptor generating module 124 uses the first artificial intelligence module 134 to parse the input data 110 from the data source 106 and to generate additional scientific descriptors as well as non-scientific descriptors representing business, commerce, technology, history, culture, political issues, ecological and environmental issues, as well as relevant global, national, or local legislation, standards, conventions, treaties, etc. from the parsed input data 110.

In an additional implementation consistent with the invention, the first artificial intelligence module 134 is configured to determine how to improve a technology, for example, to improve a catalyst. As described above, the first artificial intelligence module 134 is configured to analyze the specification 108 to evaluate the data in the specification 108. For example, the data in the specification 108 is text or other alphanumeric data. In another example, the data in the specification 108 is plotted data. In a further example, the data in the specification 108 is a graph of data. In still another example, the data in the specification 108 is a table of data. In an additional example, the data in the specification 108 is a figure. In an alternative example, the data in the specification 108 is an image. In another example, the data in the specification 108 is a trend in data. The first artificial intelligence module 134 is configured to determine how certain variables, such as in methods, compositions, and properties, either improve or hinder the performance of the technology in an application of the technology. The first artificial intelligence module 134 is configured to predict a best optimization of each of such variables to predict or determine the most optimal implementation of the technology, such as a catalyst, a ceramic, a composite, a material, etc.

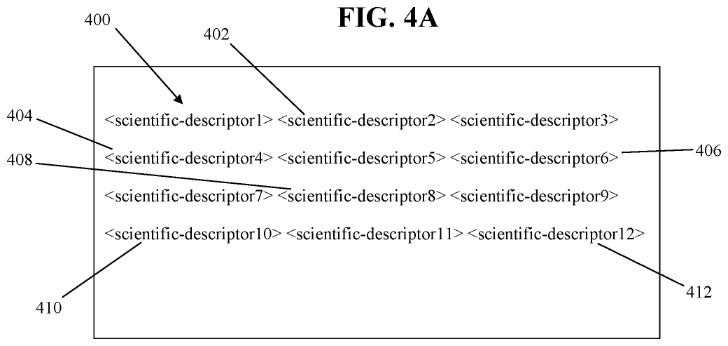

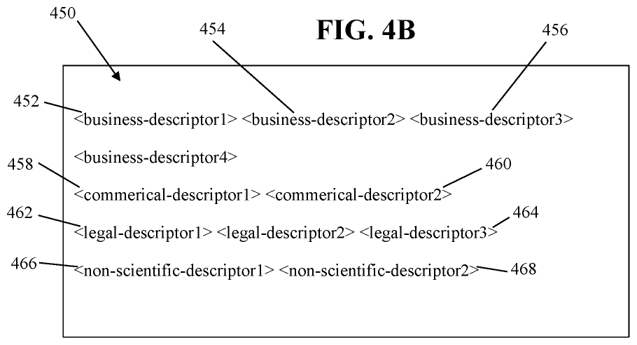

Referring to FIG. 4A, in one implementation, the descriptor generating module 124 using the first artificial intelligence module 134 generates a plurality of scientific descriptors 400 generated from words extracted from a specification 108, such as the scientific descriptors 402-412. Referring to FIG. 4B, in one implementation, the descriptor generating module 124 using the first artificial intelligence module 134 generates a plurality of non-scientific descriptors 450, such as the non-scientific descriptors 452-468 generated from words extracted from the specification 108 provided by the specification source 104, or from the input data 110 provided by the data source 106. For example, the non-scientific descriptors 450 include business descriptors 452, 454, 456; commercial descriptors 458, 460; and legal descriptors 462, 464. In another example, other non-scientific descriptors 466, 468 are generated, based on words extracted from the specification 108 or from the input data 110. In one implementation, the other non-scientific descriptors 466, 468 are generated from words related to fields such as technology, history, culture, political issues, ecological and environmental issues, as well as relevant global, national, or local legislation, standards, conventions, treaties, etc.

In one implementation, the first artificial intelligence module 134 is trained to perform such extraction of words and generation of scientific or non-scientific descriptors using a known training method and a predetermined training set of words and data descriptors. For example, the known training method is a method configured to implement natural language processing. In another example, the known training method is a method configured to implement a trained artificial neural network using a predetermined training set of words and data descriptors.

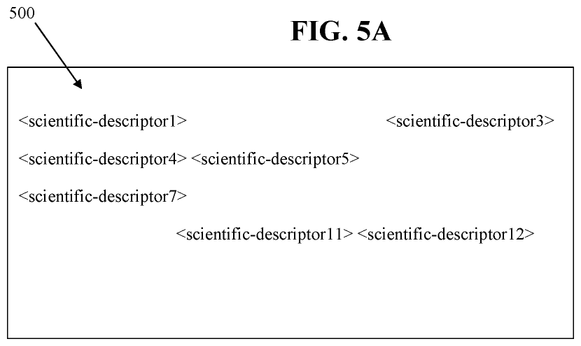

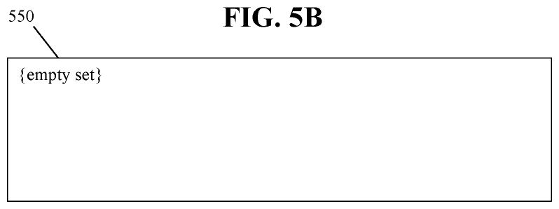

Referring to FIG. 1, the filter module 126 includes the second artificial intelligence module 136. In one implementation, the second artificial intelligence module 136 identifies scientific descriptors which match or are similar to the non-scientific descriptors using any known artificial intelligence technique, such as NLP methods. In response to receiving the data descriptors from the descriptor generating module 124, the filter module 126 filters the scientific descriptors using the second artificial intelligence module 136 to remove scientific descriptors which do not lead to viable R&D path. For example, using the scientific descriptors 400 in FIG. 4A and the non-scientific descriptors 450 in FIG. 4B, the scientific descriptors 400 are filtered to generate the filtered scientific descriptors 500 in FIG. 5A. In another example, using the scientific descriptors 400 in FIG. 4A and the non-scientific descriptors 450 in FIG. 4B, the scientific descriptors 400 are filtered to generate no scientific descriptors in the set 550 illustrated in FIG. 5B. That is, the filtered scientific descriptors results in an empty set, which represents no viable R&D path to implement the specification 108 or a project 112 directed to implementing the specification.

For example, referring to the example data descriptors described above related to ceramics, based on business descriptors such as <start-up>, <incubator>, or <investment-capital>; based on commercial descriptors such as <market-share-less-than-ten-percent> and <budget-less-than-$1000000>; and based on legal descriptors such as <no-freedom-to-operate> and <possible-patent-infringement>, the filter module 126 removes <chemically-bonded-phosphate-ceramic> as a scientific descriptor. In one implementation, the filter module 126, using the second artificial intelligence module 136, performs such filtering using a predetermined algorithm implementing a plurality of predetermined rules, thresholds, logic, and conditions.

For example, in evaluating a project 112 or specification 108 representing an R&D-based project 112, if the costs of researching, developing, and bring to market a chemically bonded phosphate ceramic costs are determined by the filter module 126 to be over a budget of $ 1,000,000, the commercial descriptor <budget-less-than-$1000000> is a condition which causes the filter module 126 to remove <chemically-bonded-phosphate-ceramic> as a scientific descriptor. In an alternative example, if the organization has a rule to not pursue R&D-based projects 112 which lack a freedom-to-operate legally, such as due to relevant local regulatory laws or legal exposure to patent infringement of a patent owned by another organization, the legal descriptor of <no-freedom-to-operate> is a condition which causes the filter module 126 to remove <chemically-bonded-phosphate-ceramic> as a scientific descriptor.

Accordingly, the filter module 126 includes the second artificial intelligence module 136 to generate the filtered scientific descriptors 500 in FIG. 5A. In one implementation, the filtered scientific descriptors 500 are the basis for a possible viable R&D path. For example, if the second artificial intelligence module 136 does not determine any red flags with respect to any known factors, such as cost, legislation, regulations, legal issues, sustainability, perceptions, and business considerations, the filtered scientific descriptors 500 are generated from all of the scientific descriptors 400 in FIG. 4A.

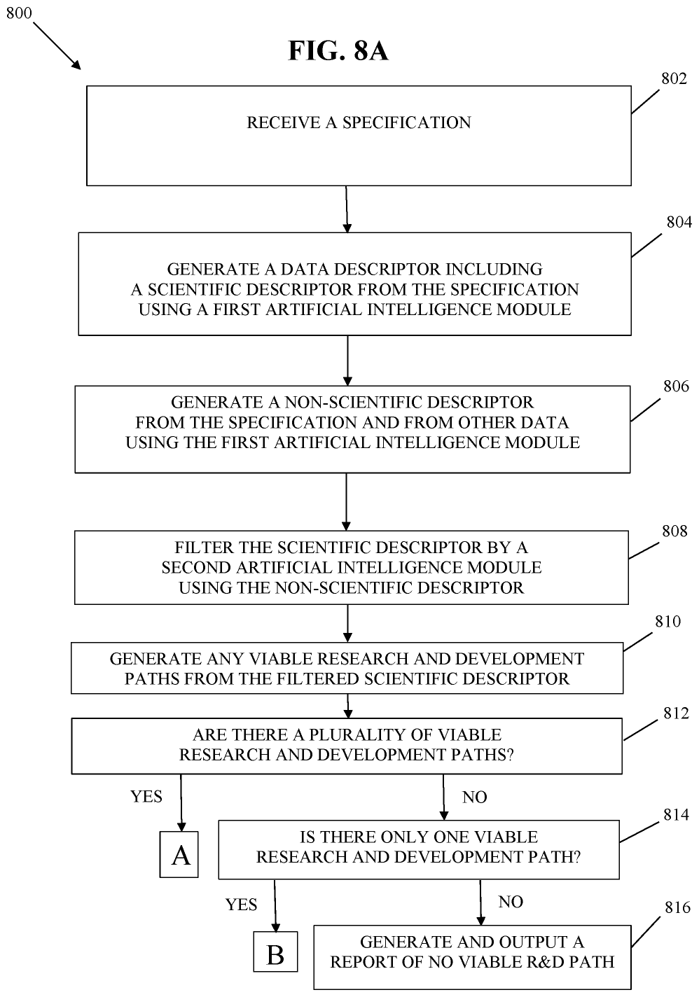

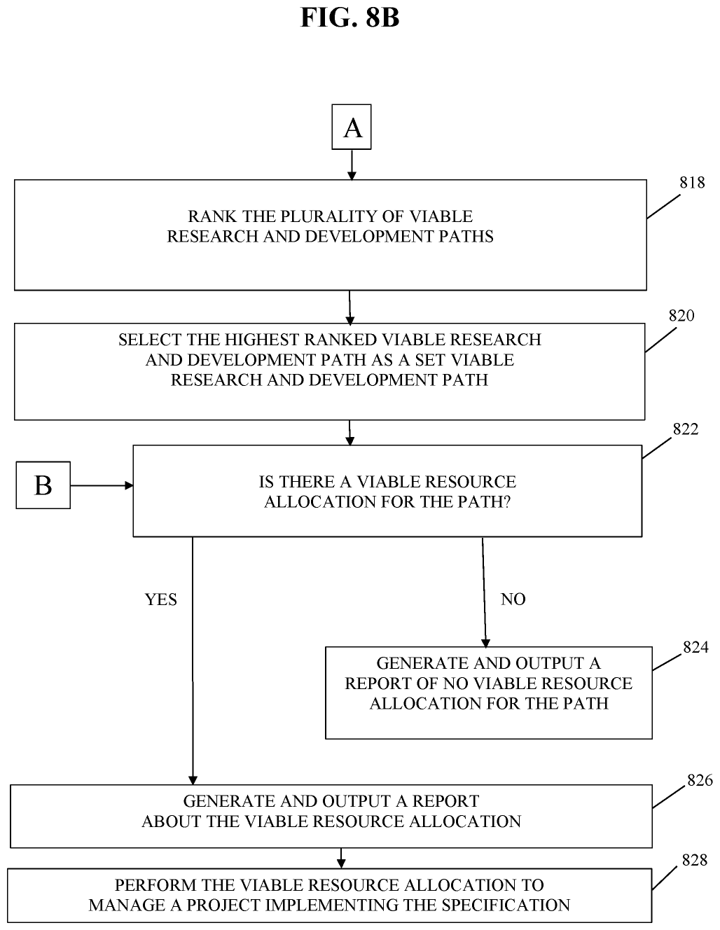

However, in another implementation, the scientific descriptors 400 are filtered to generate no scientific descriptors in the set 550 illustrated in FIG. 5B. That is, the filtered scientific descriptors results in an empty set, which represents no viable R&D path to implement the specification 108 or a project 112 directed to implementing the specification, as described below with reference to step 816 in FIG. 8A. In a further implementation, in the case that the filtered scientific descriptors is an empty set, the resource allocation system 102 sets a flag or a logic (Boolean) value indicating to the path generating module 128 that there are no filtered scientific descriptors as determined by the filter module 126. For example, the filter module 126 sets the flag or logic (Boolean) value. In an alternative example, the processor 116 sets the flag or logic (Boolean) value.

In one implementation, the second artificial intelligence module 136 is trained to perform such filtering of scientific descriptors based on non-scientific descriptors using a known training method and a predetermined training set of rules, thresholds, and conditions applied to data descriptors. For example, the known training method is a method configured to implement machine learning to implement predetermined rules, thresholds, and conditions applied to data descriptors. In another example, the known training method is a method configured to implement a trained artificial neural network using a predetermined training set of scientific descriptors and non-scientific descriptors.

In one implementation, the first artificial intelligence module 134 is distinct, different, and separate from the second artificial intelligence module 136. In another implementation, the first artificial intelligence module 134 and the second artificial intelligence module 136 are implemented by a common artificial intelligence module.

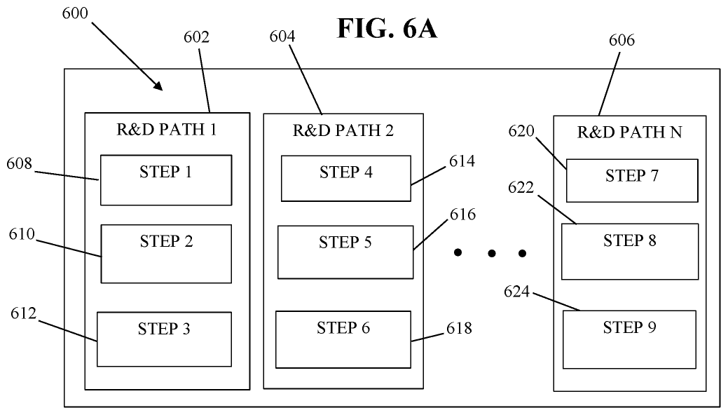

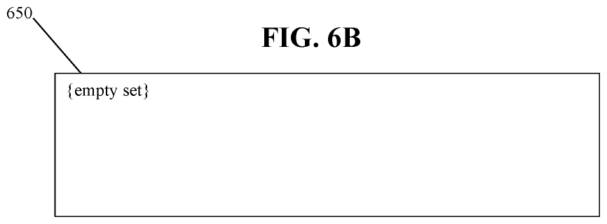

Referring to FIG. 1 in conjunction with FIGS. 5A and 6A, the path generating module 128 processes the filtered scientific descriptors 500 in FIG. 5A to generate a set 600 of viable paths for research and development (R&D), as shown in FIG. 6A, to implement the specification 108. In one implementation, a first viable R&D path 602 as a single viable R&D path. In another implementation, the path generating module 128 generates a plurality of viable R&D paths 602, 604, 606. For example, each viable R&D path 602, 604, 606 shown in FIG. 6A includes at least one step or procedure 608-624, respectively, configured to implement the specification 108. The path generating module 128 uses a known method using a predetermined algorithm to generate such viable R&D paths 602, 604, 606 based on the filtered scientific descriptors 500 in FIG. 5A. It is to be understood that, in some implementations, one or more of the steps or procedures 608-624 are identical. For example, steps 608 and 614 shown in FIG. 6A are identical, but not identical to step 620. In a further example, identical steps 608, 614 involve first procuring ingredients or materials to form a ceramic described in a specification 108, while step 620 involves first procuring a mechanical powder press to form the ceramic described in the specification 108.

Referring to back FIG. 1 in conjunction with FIGS. 5A-5B, in the case that no scientific descriptors are present in the filtered set 550 illustrated in FIG. 5B, that is, the filtered scientific descriptors results in an empty set, the path generating module 128 determines that there is no viable R&D path to implement the specification 108 or a project 112 directed to implementing the specification 108, as described below with reference to step 816 in FIG. 8A. Accordingly, in one implementation, the path generating module 128 generates an empty set 650 of viable paths, as shown in FIG. 6B. In another implementation, in response to the set flag or a logic (Boolean) value indicating that there are no filtered scientific descriptors as determined by the filter module 126, the path generating module 128 sets another flag or logic (Boolean) value indicating that there is no viable R&D path to implement the specification 108 or a project 112 directed to implementing the specification 108, as described below with reference to step 816 in FIG. 8A. The set flag or logic (Boolean) value of no viable R&D path is used by input/output device 120 to generate and output the report 114, as described below with reference to step 816 in FIG. 8A.

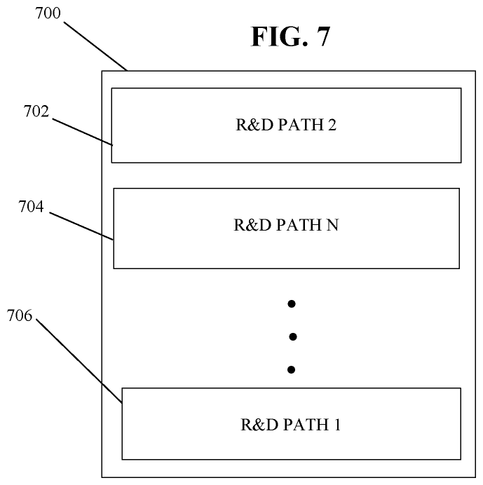

In one implementation, the path generating module 128 is configured to rank the viable R&D paths 602, 604, 606 shown in FIG. 6A into a ranked list 700 of viable R&D paths 702, 704, 706, as shown in FIG. 7. For example, the path generating module 128 performs the ranking of viable R&D paths 702, 704, 706 using a predetermined ranking criterion. In one implementation, the predetermined ranking criterion evaluates each viable R&D paths 602, 604, 606 shown in FIG. 6A according to the overall cost for implementing each viable R&D paths 602, 604, 606, with the ranking sorted in the ranked list 700 by the path generating module 128 in ascending order downward in the ranked list 700 from lowest cost to highest cost. In another implementation, the predetermined ranking criterion evaluates each viable R&D paths 602, 604, 606 shown in FIG. 6A according to an expected return on investment (ROI) to the organization for each viable R&D paths 602, 604, 606, with the ranking sorted in the ranked list 700 by the path generating module 128 in descending order downward in the ranked list 700 from highest, greatest, or maximum ROI to a lowest, least, or minimum ROI. The top ranked viable R&D path 702 is set as the R&D path which meets the predetermined criterion as the optimal or best viable R&D path relative to the predetermined criterion.

In an additional implementation, the predetermined ranking criterion uses any known factors, such as legislation, regulations, legal issues, sustainability, perceptions, and business considerations. For example, legislation or regulations prohibiting or regulating the use or discharge of a chemical adversely affects the viability of an R&D path, and so reduces the ranking of such an affected R&D path. In another example, legal issues which protects a composition or method by patents, designs, copyright, trade dress, etc. which adversely affect the viability of an R&D path reduces the ranking of such an affected R&D path. In a further example, sustainability or perceptions such as public image or bad publicity such as the methods of using or discharging a chemical increases risks which a company or organization may not want to be associated with, such as adverse effects of a chemical on an environment, on personnel, and on assets, reduces the ranking of such an affected R&D path. In another example, business considerations such as a lack of facilities to properly handle a new chemical, composition, process, or method also reduce the ranking of such an affected R&D path.

In one implementation, the predetermined ranking criterion is a default setting of the path generating module 128. In another implementation, the predetermined ranking criterion is set or modified by a system administrator or a project manager or administrator by entering data inputs into the input/output device 120.

In one implementation, the path generating module 128 provides the ranked list 700 to the input/output device 120 to be output in the report 114. For example, the ranked list 700 is displayed in the report 114 on a display or monitor. In another example, the ranked list 700 is printed in the report 114 on a hardcopy by a printer. Such an outputted report 114 including the ranked list 700 is available for viewing by a project manager or executive of an organization. For example, the outputted report 114 is a text or graphic displayed visually on a display or monitor, with the report 114 visually or graphically listing the ranked list 700, and is output to a project manager or project team. In another example, the report 114 is an audible report output as audio through a speaker of the input/output device 120. In still another example, the report 114 is a computer file listing the ranked list 700. In one implementation, the computer file in the report 114 includes the top ranked R&D path 702, which is automatically sent to a fabrication system, such as a three-dimensional (3D) printer, to implement the fabrication of a material using the top ranked R&D path 702. Alternatively, the fabrication system is a chemical plant operating in connection with petrochemical production, with the report 114 including control data and a top ranked R&D path 702 to implement the fabrication of new substances as a material using an allocation of resources provided to the chemical plant, such as raw materials and ingredients. In another implementation, the path generating module 128 sets the highest ranked viable R&D path 702 shown in FIG. 7 as a set viable R&D path for use by the allocation generating module 130.

The allocation generating module 130 uses a known allocation method, such as a known project management method, to determine whether there is a viable allocation of resources of an allocation. In one implementation, the allocation generating module 130 is configured to perform enterprise resource planning (ERP) using a known ERP system or software to provide integrated management of main business processes of an organization. In another implementation, the allocation generating module 130 using the ERP system interacts with a project team to allocate resources to the top ranked R&D path 702 forward which is determined to be the most viable based on the predetermined criterion. The allocation generating module 130 is configured to allocate people, equipment, facilities, costs, funding, materials, time, etc.

For example, if the organization has available suppliers of the ingredients and materials, has available equipment to perform the viable R&D path, and has available infrastructure such as a clean room or other facilities to implement the set viable R&D path to fabricate, create, realize, or grow a new material according to the specification 108, the allocation generating module 130 allocates the available resources of an organization to implement the set viable R&D path 702. In one implementation, the allocation generating module 130 instructs the input/output device 120 to output the report 114 including the viable resource allocation. The output report 114 with the viable resource allocation allows a project manager or an executive of the organization to initiate implementation of the project 112 with the viable R&D path 702. In another implementation, the project management module 132 receives the viable resource allocation. In a further implementation, the project management module 132 automatically implements the allocated resources to implement the project 112 with the viable R&D path 702. For example, the project management module 132 operates in accordance with the ISO 9000 standard. In another example, the project management module 132 operates in accordance with known business process modeling (BPM) techniques. In a further example, the project management module 132 executes any commercially available project management software.

In another example of operation of the allocation generating module 130, if the organization does not have one or more of the necessary ingredients, materials, equipment, infrastructure, or other necessary matters such as budget for the set viable R&D path 702, the allocation generating module 130 determines that there is no viable allocation of resources of the organization for the set viable R&D path 702. For example, in determining that there is no viable allocation, the allocation generating module 130 instructs the input/output device 120 to output the report 114 indicating that there is no viable allocation of resources. Such an output report 114 allows a project manager or executive of the organization to assess whether to remedy such a lack of resources in order to implement the set viable R&D path 702.

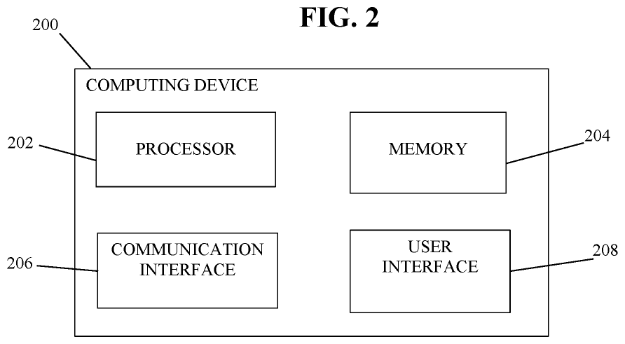

FIG. 2 illustrates a schematic of a computing device 200 including a processor 202 having code therein, a memory 204, and a communication interface 206. Optionally, the computing device 200 can include a user interface 208, such as an input device, an output device, or an input/output device. The processor 202, the memory 204, the communication interface 206, and the user interface 208 are operatively connected to each other via any known connections, such as a system bus, a network, etc. Any component, combination of components, and modules of the system 100 in FIG. 1 can be implemented by a respective computing device 200. For example, each of the components 102, 104, 106, and 114-136 shown in FIG. 1 can be implemented by a respective computing device 200 shown in FIG. 2 and described below.

It is to be understood that the computing device 200 can include different components. Alternatively, the computing device 200 can include additional components. In another alternative implementation, some or all of the functions of a given component can instead be carried out by one or more different components. The computing device 200 can be implemented by a virtual computing device. Alternatively, the computing device 200 can be implemented by one or more computing resources in a cloud computing environment. Additionally, the computing device 200 can be implemented by a plurality of any known computing devices.

In an implementation consistent with the invention, the processor 116 of FIG. 1 is implemented by the processor 202 in FIG. 2. The processor 202 can be a hardware-based processor implementing a system, a sub-system, or a module. The processor 202 can include one or more general-purpose processors. Alternatively, the processor 202 can include one or more special-purpose processors. The processor 202 can be integrated in whole or in part with the memory 204, the communication interface 206, and the user interface 208. In another alternative implementation, the processor 202 can be implemented by any known hardware-based processing device such as a controller, an integrated circuit, a microchip, a central processing unit (CPU), a microprocessor, a system on a chip (SoC), a field-programmable gate array (FPGA), or an application-specific integrated circuit (ASIC). In addition, the processor 202 can include a plurality of processing elements configured to perform parallel processing. In a further alternative implementation, the processor 202 can include a plurality of nodes or artificial neurons configured as an artificial neural network. The processor 202 can be configured to implement any known artificial neural network, including a convolutional neural network (CNN).

In an implementation consistent with the invention, the memory 118 of FIG. 1 is implemented by the memory 204 of FIG. 2. The memory 204 can be implemented as a non-transitory computer-readable storage medium such as a hard drive, a solid-state drive, an erasable programmable read-only memory (EPROM), a universal serial bus (USB) storage device, a floppy disk, a compact disc read-only memory (CD-ROM) disk, a digital versatile disc (DVD), cloud-based storage, or any known non-volatile storage.

The code of the processor 202 can be stored in a memory internal to the processor 202. The code can be instructions implemented in hardware. Alternatively, the code can be instructions implemented in software. The instructions can be machine-language instructions executable by the processor 202 to cause the computing device 200 to perform the functions of the computing device 200 described herein. Alternatively, the instructions can include script instructions executable by a script interpreter configured to cause the processor 202 and computing device 200 to execute the instructions specified in the script instructions. In another alternative implementation, the instructions are executable by the processor 202 to cause the computing device 200 to execute an artificial neural network. The processor 202 can be implemented using hardware or software, such as the code. The processor 202 can implement a system, a sub-system, or a module, as described herein.

The memory 204 can store data in any known format, such as databases, data structures, data lakes, or network parameters of a neural network. The data can be stored in a table, a flat file, data in a filesystem, a heap file, a B+ tree, a hash table, or a hash bucket. The memory 204 can be implemented by any known memory, including random access memory (RAM), cache memory, register memory, or any other known memory device configured to store instructions or data for rapid access by the processor 202, including storage of instructions during execution.

In an implementation consistent with the invention, the communication interface 122 of FIG. 1 is the communication interface 206 of FIG. 2. The communication interface 206 can be any known device configured to perform the communication interface functions of the computing device 200 described herein. The communication interface 206 can implement wired communication between the computing device 200 and another entity. Alternatively, the communication interface 206 can implement wireless communication between the computing device 200 and another entity. The communication interface 206 can be implemented by an Ethernet, Wi-Fi, Bluetooth, or USB interface. The communication interface 206 can transmit and receive data over a network and to other devices using any known communication link or communication protocol.

In an implementation consistent with the invention, the input/output device 120 of FIG. 1 is implemented by the user interface 208 in FIG. 2. The user interface 208 can be any known device configured to perform user input and output functions. The user interface 208 can be configured to receive an input from a user. Alternatively, the user interface 208 can be configured to output information to the user. The user interface 208 can be a computer monitor, a television, a loudspeaker, a computer speaker, or any other known device operatively connected to the computing device 200 and configured to output information to the user. A user input can be received through the user interface 208 implementing a keyboard, a mouse, or any other known device operatively connected to the computing device 200 to input information from the user. Alternatively, the user interface 208 can be implemented by any known touchscreen. The computing device 200 can include a server, a personal computer, a laptop, a smartphone, or a tablet.

Referring to FIGS. 8A-8B, a method 800 of operation of the system 100 includes receiving a specification 108 in step 802. As described above, the specification 108 is a description including a structure, a composition, a property, performance information, a function, a method to make, or an operating parameter. In one implementation, the specification 108 is a description of a material or a composition of matter to be fabricated, created, realized, or grown, such as a composite material. For example, the material or composition of matter is a chemical including a catalyst, a polymer, or a pharmaceutical. In another implementation, the specification 108 is a description of a machine to be fabricated, such as a computer-based device. In a further implementation, the specification 108 is a goal of a project, such as the project 112. For example, the project 112 is configured to design, simulate, fabricate, create, realize, or grow a material or a composition of matter, such as a chemical including a catalyst, a polymer, or a pharmaceutical. In another example, the project 112 is configured to design, simulate, fabricate, or create a software project such as an application. In a further example, the project 112 is an R&D program. In yet another implementation, the specification 108 describes any known item, idea, application, or process to be designed, simulated, fabricated, created, realized, or grown. In one implementation, the specification 108 is input to the communication interface 122 of the resource allocation system 102 in FIG. 1. As described above, example specifications 300, 350 are illustrated in FIGS. 3A-3B, respectively.

The method 800 then generates at least one data descriptor including at least one scientific descriptor from the specification 108 using the first artificial intelligence module 134 in step 804, and generates at least one non-scientific descriptor from at least one of the specification 108 and from other data such as the input data 110 using the first artificial intelligence module in step 806. FIG. 4A illustrates a plurality of scientific descriptors 400 generated from words extracted from a specification 108, such as the scientific descriptors 402-412. FIG. 4B illustrates a plurality of non-scientific descriptors 450, such as the non-scientific descriptors 452-468 generated from words extracted from the specification 108 provided by the specification source 104, or from the input data 110 provided by the data source 106. In one implementation, the non-scientific descriptors 450 include business descriptors 452, 454, 456; commercial descriptors 458, 460; and legal descriptors 462, 464. In another implementation, other non-scientific descriptors 466, 468 are generated, based on words extracted from the specification source 104 or from the input data 110. For example, the other non-scientific descriptors 466, 468 are generated from words related to fields such as technology, history, culture, political issues, ecological and environmental issues, as well as relevant global, national, or local legislation, standards, conventions, treaties, etc.

The method 800 then filters the at least one scientific descriptor 400 by the filter module 126 using the second artificial intelligence module 136 and using the at least one non-scientific descriptor using in step 808. FIGS. 5A-5B illustrate filtered sets 500, 550 of the scientific descriptors 400 of FIG. 4A. As shown in FIG. 5A, the filtered set 500 has fewer but a non-zero number of scientific descriptors compared with the scientific descriptors 400 of FIG. 4A. As shown in FIG. 5B, the filtered set 550 has no scientific descriptors. The method 800 then generates any viable R&D paths from the filtered at least one scientific descriptor in step 810 using the path generating module 128. The method 800 then determines whether there are a plurality of viable R&D paths in step 812. If there are a plurality 600 of viable R&D paths 602-606 in step 812, as shown in FIG. 6A, the method 800 proceeds to step 818 in FIG. 8B. Otherwise, the method 800 proceeds to step 814 to determine if there is only one viable R&D path, such as just the single viable R&D path 602 in FIG. 6A. If there is only one viable R&D path 602 in step 814, the method 800 proceeds to step 822 in FIG. 8B. Otherwise, if there are no viable R&D paths generated in step 810, as shown in the empty set 650 in FIG. 6B, the method 800 generates and outputs a report 114 in step 816 indicating that there are no viable R&D path for implementing the specification 108. In one implementation, a project management team, project manager, or an executive of an organization accesses the report 114 and optionally remedies the circumstances such that no viable R&D path exists. For example, in view of the report 114, the project management team, the project manager, or the executive determines whether to proceed with remedying the circumstances of the project to find a viable R&D path.

Referring to FIG. 8B, the method 800 optionally performs steps 818-820. In step 818, the method 800 ranks the plurality of viable R&D paths 702-706 in a ranked list 700, as shown in FIG. 7. The ranking of the plurality of viable R&D paths 702-706 is performed by the path generating module 128. In one implementation, step 818 also includes outputting the ranked list 700 of the plurality of viable R&D paths 702-706 in the report 114, using the input/output device 120 as described above. FIG. 6A illustrates a set 600 of viable R&D paths 602-606, such as a single viable R&D path 602 or a plurality 602-606, and FIG. 7 illustrates a ranked set 700 of the viable R&D paths 702-706.

The method 800 then proceeds to step 820 to set the highest ranked viable R&D path 702 as a set viable R&D path. The setting of the highest ranked viable R&D path 702 to be the set viable R&D path is performed by the path generating module 128. The method 800 then determines in step 822 whether there is a viable resource allocation for the set viable R&D path 702. Referring back to step 814, if there is only one viable R&D path 602, the method 800 proceeds to step 822 to determine whether there is a viable resource allocation for the single viable R&D path 602 using the allocation generating module 130.

If there is no viable resource allocation for the set or single R&D path 602 in step 822 as determined by the allocation generating module 130, the method 800 proceeds to step 824 to generate and output a report 114 using the input/output device 120, with the report 114 indicating that there is no viable resource allocation for the set or single R&D path 602. In one implementation, a project management team, project manager, or an executive of an organization accesses the report 114 and optionally remedies the circumstances such that no viable resource allocation exists. For example, in view of the report 114, the project management team, the project manager, or the executive determines whether to proceed with remedying the circumstances of the project to find a viable resource allocation. Otherwise, in step 822, if there is a viable resource allocation for the set viable R&D path 702 determined by the allocation generating module 130, the method 800 proceeds to step 826 to generate and output a report 114 using the input/output device 120, with the report 114 indicating the viable resource allocation.

The method 800 then performs the viable resource allocation in step 828. For example, the project management module 132 automatically performs the viable resource allocation to implement the project 112. In another example, in step 828, the method 800 operates the system 100 to implement the specification 108 using other known project management systems or applications. In one implementation, the method 800 in step 828 manages a project 112 to implement the specification 108. As described above, in an implementation consistent with the invention, the specification 108 is a goal of a project, such as the project 112. For example, the project 112 is configured to design, simulate, fabricate, create, realize, or grow a material or a composition of matter, such as a chemical including a catalyst, a polymer or a pharmaceutical. In another example, the project 112 is configured to design, simulate, fabricate, or create a software project such as an application. In a further example, the project 112 is an R&D program. In yet another implementation, the specification 108 describes any known item, idea, application, or process to be designed, simulated, fabricated, created, realized, or grown.

Using the system 100 and method 800, scientific descriptors and non-scientific descriptors such as business descriptors, commercial descriptors, and legal descriptors provide for focused scientific descriptors to allow for a more focused material design and implementations of specifications 108 having a more viable commercial path forward, thus improving how resources in an organization are allocated to a project 112 with time and money savings, as well as a more viable deployment of products, processes, and technology. Such filtering of scientific descriptors allows an informed early decision by a project manager or an executive of the organization as to whether the suggested R&D path forward based on scientific descriptors is viable when considering the other data descriptors such as business descriptors, commercial descriptors, and legal descriptors.

Portions of the methods described herein can be performed by software or firmware in machine readable form on a tangible or non-transitory storage medium. For example, the software or firmware can be in the form of a computer program including computer program code adapted to cause the system to perform various actions described herein when the program is run on a computer or suitable hardware device, and where the computer program can be implemented on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments, implementations, or arrangements.

The terminology used herein is for the purpose of describing particular implementations only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments and implementations, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to implementations of the disclosure without departing from the essential scope thereof. Therefore, it is intended that the invention not be limited to the particular implementations disclosed, or to the best mode contemplated for carrying out this invention, but that the invention will include all implementations falling within the scope of the appended claims.

The subject matter described above is provided by way of illustration only and should not be construed as limiting. Various modifications and changes can be made to the subject matter described herein without following the example embodiments, implementations, and applications illustrated and described, and without departing from the true spirit and scope of the invention encompassed by the present disclosure, which is defined by the set of recitations in the following claims and by structures and functions or steps which are equivalent to these recitations.

Upon entry of this Preliminary Amendment, the listing of claims is as follows:

1. A resource allocation system, comprising:
a hardware-based processor;
a memory configured to store instructions and configured to provide the instructions to the hardware-based processor; and
a set of modules configured to implement the instructions provided to the hardware-based processor, the set of modules including:
a descriptor generating module configured to generate a plurality of scientific descriptors from a specification, and to generate a non-scientific descriptor from input data;
a filter module configured to filter the plurality of scientific descriptors using the non-scientific descriptor, thereby to generate a filtered set of scientific descriptors;
a path generating module configured, responsive to the filtered set of scientific descriptors, to generate at least one viable research and development (R&D) path; and
an allocation generating module configured, responsive to the at least one viable R&D path, to allocate a plurality of resources to implement the specification.

2. The resource allocation system of claim 1, wherein the specification includes at least one first string of alphanumeric characters; and
wherein the descriptor generating module includes an artificial intelligence module configured to extract a first keyword from the at least one first string of alphanumeric characters, and to generate the plurality of scientific descriptors from the extracted first keyword, any other input data, or both.

3. The resource allocation system of claim 2, wherein the input data includes at least one second string of alphanumeric characters; and
wherein the artificial intelligence module is configured to extract a second keyword from the at least one second string of alphanumeric characters, and to generate a plurality of non-scientific descriptors from the extracted second keyword, any other input data, or both.

4. The resource allocation system of claim 2, wherein the artificial intelligence module includes a natural language processing (NLP) module configured to extract a first keyword from the at least one first string of alphanumeric characters.

5. The resource allocation system of claim 1, wherein the filter module includes an artificial intelligence module configured to filter the plurality of scientific descriptors using the non-scientific descriptor.

6. The resource allocation system of claim 1, wherein the path generating module is configured, responsive to the filtered set of scientific descriptors, to generate a plurality of viable research and development (R&D) paths.

7. The resource allocation system of claim 6, wherein the path generating module is configured to sort and rank the plurality of viable R&D paths based on a predetermined ranking criterion.

8. The resource allocation system of claim 7, wherein the path generating module is configured to sort and rank the plurality of viable R&D paths from least costly to most costly as the predetermined ranking criterion.

9. The resource allocation system of claim 7, wherein the path generating module is configured to sort and rank the plurality of viable R&D paths from a greatest return on investment (ROI) to a least ROI as the predetermined ranking criterion.

10. A system, comprising:
a specification source configured to store a specification having at least one first string of alphanumeric characters;
a data source configured to store input data having at least one second string of alphanumeric characters; and
a resource allocation sub-system including:
a hardware-based processor;
a memory configured to store instructions and configured to provide the instructions to the hardware-based processor; and
a set of modules configured to implement the instructions provided to the hardware-based processor, the set of modules including:
a descriptor generating module configured to generate a plurality of scientific descriptors from the specification, and to generate a non-scientific descriptor from the input data;
a filter module configured to filter the plurality of scientific descriptors using the non-scientific descriptor, thereby to generate a filtered set of scientific descriptors;
a path generating module configured, responsive to the filtered set of scientific descriptors, to generate at least one viable research and development (R&D) path; and
an allocation generating module configured, responsive to the at least one viable R&D path, to allocate a plurality of resources to implement the specification.

11. The system of claim 10, wherein the descriptor generating module includes an artificial intelligence module configured to extract a first keyword from the at least one first string of alphanumeric characters, and to generate the plurality of scientific descriptors from the extracted first keyword, any other input data, or both.

12. The system of claim 10, wherein the artificial intelligence module is configured to extract a second keyword from the at least one second string of alphanumeric characters, and to generate a plurality of non-scientific descriptors from the extracted second keyword, any other input data, or both.

13. The system of claim 12, wherein the artificial intelligence module includes a natural language processing (NLP) module configured to extract a first keyword from the at least one first string of alphanumeric characters.

14. The system of claim 10, wherein the filter module includes an artificial intelligence module configured to filter the plurality of scientific descriptors using the non-scientific descriptor.

15. The system of claim 10, wherein the path generating module is configured, responsive to the filtered set of scientific descriptors, to generate a plurality of viable research and development (R&D) paths.

16. The system of claim 15, wherein the path generating module is configured to sort and rank the plurality of viable R&D paths based on a predetermined ranking criterion.

17. The system of claim 16, wherein the path generating module is configured to sort and rank the plurality of viable R&D paths from least costly to most costly as the predetermined ranking criterion.

18. The system of claim 16, wherein the path generating module is configured to sort and rank the plurality of viable R&D paths from a greatest return on investment (ROI) to a least ROI as the predetermined ranking criterion.

19. A computer-based method, comprising:
providing a specification having at least one first string of alphanumeric characters;
providing input data having at least one second string of alphanumeric characters;
generating a plurality of scientific descriptors from the specification;
generating a non-scientific descriptor from the input data;
filtering the plurality of scientific descriptors using the non-scientific descriptor, thereby generating a filtered set of scientific descriptors;
responsive to the filtered set of scientific descriptors, generating at least one viable research and development (R&D) path; and
responsive to the at least one viable R&D path, allocating a plurality of resources to implement the specification.

20. The computer-based method of claim 19, wherein generating the plurality of scientific descriptors further comprises:
performing natural language processing (NLP) on the at least one first string of alphanumeric characters in the specification;
extracting a first keyword from at least one first string of alphanumeric characters; and
generating the plurality of scientific descriptors from the extracted first keyword, any other input data, or both.
